(19) United States
(12) Patent Application Publication
(10) Pub. No.: US 2014/0037212 A1
(43) Pub. Date: Feb. 6, 2014

(54) IMAGE PROCESSING METHOD AND DEVICE

(71) Applicant: FUJIFILM Corporation, Tokyo (JP)

(72) Inventor: Hisashi ENDO, Saitama-shi (JP)

(73) Assignee: FUJIFILM Corporation, Tokyo (JP)

(21) Appl. No.: 14/046,432

(22) Filed: Oct. 4, 2013

Related U.S. Application Data
(63) Continuation of application No. PCT/JP2012/057874, filed on Mar. 27, 2012.

(30) Foreign Application Priority Data
Apr. 7, 2011 (JP) 2011-085436

(51) Int. Cl. G06T 7/20

(52) U.S. Cl. CPC G06T 7/204
USPC 382/195

(57) ABSTRACT

Feature points are extracted from a reference frame. Matching points corresponding to the respective feature points are extracted from a tracking frame. The reference and tracking frames are consecutive in time series. An inverse vector, corresponding to motion of the whole screen, having the matching point as a starting point is obtained. An endpoint of the inverse vector is calculated as a moved point. The matching point is classified as a stationary point when a position of the moved point is within a predetermined range relative to a position of the feature point. When the position of the moved point is out of the predetermined range, whether a correlation between the moved point and the feature point is high is determined. When the correlation is high, the matching point is classified as the outlier. When the correlation is low, the matching point is classified as a moving point.

### BACKGROUND OF THE INVENTION

1. Field of the Invention

The present invention relates to an image processing method and an image processing device for detecting motion of a subject from a change in position of a feature point between image frames.

2. Description Related to the Prior Art Motion of a subject is detected by extracting feature points from a reference image frame (hereinafter referred to as the reference frame) and extracting matching points corresponding to the respective feature points from an image frame (hereinafter referred to as the tracking frame). The reference frame and the tracking frame are consecutive in time series. The motion of the subject corresponding to an image having the feature points is detected with the use of motion vectors. Each motion vector extends from a feature point to a matching point corresponding to the feature point.

For example, when the motion vectors are in the same direction and have substantially the same magnitude, the subject corresponding to the image having the feature points is assumed to be stationary. A subject corresponding to a motion vector different in direction or magnitude from the motion vector corresponding to the stationary subject is assumed to be a moving subject.

The matching points are extracted by pattern matching using a luminance value or the like. If an area close to an area, being the feature point, has a feature similar to that of the feature point, the area may be extracted as a matching point by error (the so-called outlier). When the outlier occurs, a stationary subject is detected as a moving subject. This reduces motion detection accuracy of the subject.

A motion estimation device disclosed in Japanese Patent Laid-Open Publication No. 2010-157093 uses pattern information, for example, edge distribution around a feature point, as a feature value. The motion estimation device obtains the feature value of each of a feature point and other feature points around the feature point and determines whether the feature point is apt to cause the outlier based on the obtained feature values. The feature point apt to cause the outlier is eliminated to prevent the occurrence of the outlier and the reduction in the motion detection accuracy resulting from the outlier.

Generally, an image of a scene (hereinafter referred to as the scene with a repeated pattern) in which areas with similar features appear repeatedly is apt to cause the outlier. For example, in an image of a building with windows of the same shape provided at regular intervals, a feature point is often similar to its surrounding pattern. This arises a problem that the outlier cannot be avoided even if information of the surrounding pattern is used as disclosed in the Japanese Patent Laid-Open Publication No. 2010-157093.

When the outlier actually occurs, the matching point, being the outlier, is handled as the matching point on the moving subject. Conventionally, a method for determining whether the motion of the matching point is due to the motion of the subject or due to the outlier has not been devised.

### SUMMARY OF THE INVENTION

An object of the present invention is to provide an image processing device and an image processing method for preventing occurrence of an outlier in a scene with a repeated pattern and correctly determining whether motion of a matching point is due to motion of a subject or due to the outlier.

In order to achieve the above objects, the image processing device of the present invention comprises a feature point extractor, a matching point extractor, a motion calculator, a moved point calculator, and a classification determiner. The feature point extractor extracts feature points from a reference frame. The matching point extractor extracts matching points from a tracking frame. The reference frame and the tracking frame are consecutive in time series. The matching points correspond to the feature points. The motion calculator calculates motion of a whole screen of the tracking frame, relative to the reference frame, based on motion vectors from the feature points to the respective matching points. The moved point calculator obtains inverse vectors of the motion of the whole screen. The inverse vectors have the matching points as their respective starting points. The moved point calculator calculates a position of an endpoint of the inverse vector as a moved point. The classification determiner determines whether the position of the moved point is within a predetermined range relative to the position of the feature point. When the position of the moved point is within the predetermined range, the matching point is classified as a stationary point. When the position of the moved point is out of the predetermined range, a correlation between the feature point and the moved point or a correlation between the matching point and the moved point is determined. When the correlation is high, the matching point is classified as an outlier. When the correlation is low, the matching point is classified as a moving point.

It is preferable that the image processing device is provided with a starting point changer for changing the starting point, of the motion vector of the matching point, from the feature point to the moved point when the matching point is classified as the outlier.

It is preferable that the image processing device is provided with a matching point adder for adding a matching point based on the motion vector extending from the feature point corresponding to the matching point, being the outlier, and along the motion of the whole screen when the matching point is classified as the outlier.

It is preferable that the image processing device is provided with a matching point set generator, a normalizer, and an outlier determiner. The matching point set generator extracts the matching points from each of the tracking frames. When the each matching point is classified as the moving point, the matching point set generator groups the matching points as a matching point set. The normalizer normalizes the motion vector of the each matching point in the matching point set to magnitude per unit time. The outlier determiner checks whether a distance from each normalized matching point is less than or equal to a predetermined value. When the distance is less than or equal to the predetermined value, the outlier determiner determines that the each matching point included in the matching point set has a correct correspondence. When the distance is greater than the predetermined value, the outlier determiner determines that the matching point included in the matching point set is the outlier.

It is preferable that the image processing device is provided with a re-evaluator for re-evaluating whether the matching point is valid when the matching point set includes the only one matching point.

It is preferable that the image processing device is provided with a speed calculator for calculating a speed of a subject, corresponding to an image in the frame, based on a length of the motion vector and a length of the inverse vector.

It is preferable that the image processing device is provided with an exposure controller for setting an exposure condition for preventing a subject blur based on the speed of the subject.

It is preferable that the image processing device is provided with a subject blur corrector for determining a direction of motion of a subject based on a direction of the motion vector and correcting a subject blur.

It is preferable that the image processing device is provided with a subject tracker for determining a direction of motion of a subject based on a direction of the motion vector and tracking the subject.

It is preferable that the image processing device is provided with an area divider for dividing the frame, into a motion area and a stationary area, based on magnitude of the motion vector and performing image processing in accordance with a type of the area.

The image processing method according to the present invention comprises a feature point extracting step, a matching point extracting step, a motion calculating step, a moved point calculating step, and classifying step. In the feature point extracting step, feature points are extracted from a reference frame. In the matching point extracting step, matching points corresponding to the feature points are extracted from a tracking frame. The reference frame and the tracking frame are consecutive in time series. In the motion calculating step, motion of a whole screen of the tracking frame relative to the reference frame is calculated based on motion vectors from the feature points to the respective matching points. In the moved point calculating step, inverse vectors of the motion of the whole screen are obtained. The inverse vectors have the matching points as their respective starting points. A position of an endpoint of the inverse vector is calculated as a moved point. In the classifying step, whether a position of the moved point is within a predetermined range relative to a position of the feature point is determined. When the position of the moved point is within the predetermined range, the matching point is classified as a stationary point. When the position of the moved point is out of the predetermined range, a correlation between the feature point and the moved point or a correlation between the matching point and the moved point is determined. When the correlation is high, the matching point is classified as the outlier. When the correlation is low, the matching point is classified as the moving point.

According to the present invention, whether the position of the moved point is within a predetermined range relative to the position of the feature point is determined. When the position of the moved point is within the predetermined range, the matching point is classified as the stationary point. When the position of the moved point is out of the predetermined range, the correlation between the feature point and the moved point or the correlation between the matching point and the moved point is determined. When the correlation is high, the matching point is classified as the outlier. When the correlation is low, the matching point is classified as the moving point. Thereby, the occurrence of the outlier is prevented even in the scene with a repeated pattern. Whether the motion of the matching point is due to the motion of the subject or due to the outlier is determined correctly.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a block diagram illustrating configuration of an image processing device;

FIG. 2 is an explanatory view illustrating an example of a reference frame;

FIG. 3 is an explanatory view illustrating an example of a tracking frame;

FIG. 4 is an explanatory view illustrating an example of calculation of a moved point;

FIG. 5 is a flowchart schematically illustrating a procedure of the image processing device;

FIG. 6 is a flowchart illustrating an example in which an order of determining classification of the matching point is changed;

FIG. 7 is a flowchart illustrating an example in which whether it is an outlier or a moving point is determined based on a correlation between the moved point and the matching point;

FIG. 8 is a block diagram illustrating an example in which a starting point of a motion vector is changed;

FIG. 9 is an explanatory view illustrating the motion vector with the changed starting point;

FIG. 10 is a flowchart illustrating a procedure for changing the starting point of the motion vector;

FIG. 11 is a block diagram illustrating an example in which a matching point is added;

FIG. 12 is an explanatory view illustrating the added matching point;

FIG. 13 is a flowchart illustrating a procedure for adding a matching point;

FIG. 14 is a block diagram illustrating an example in which an outlier of a moving point is determined;

FIG. 15 is an explanatory view illustrating an example of generation of a matching point set;

FIG. 16 is an explanatory view illustrating an example of normalization of a motion vector;

FIG. 17 is a flowchart illustrating a procedure in which the outlier of the moving point is determined;

FIG. 18 is a block diagram illustrating an example in which re-evaluation is performed when the number of the matching point included in the matching point set is one;

FIG. 19 is a flowchart illustrating a procedure of the re-evaluation performed when the number of the matching point in the matching point set is one; and

FIG. 20 is a block diagram illustrating a digital camera incorporating the image processing device shown in FIG. 1.

### DESCRIPTION OF THE PREFERRED EMBODIMENTS

### First Embodiment

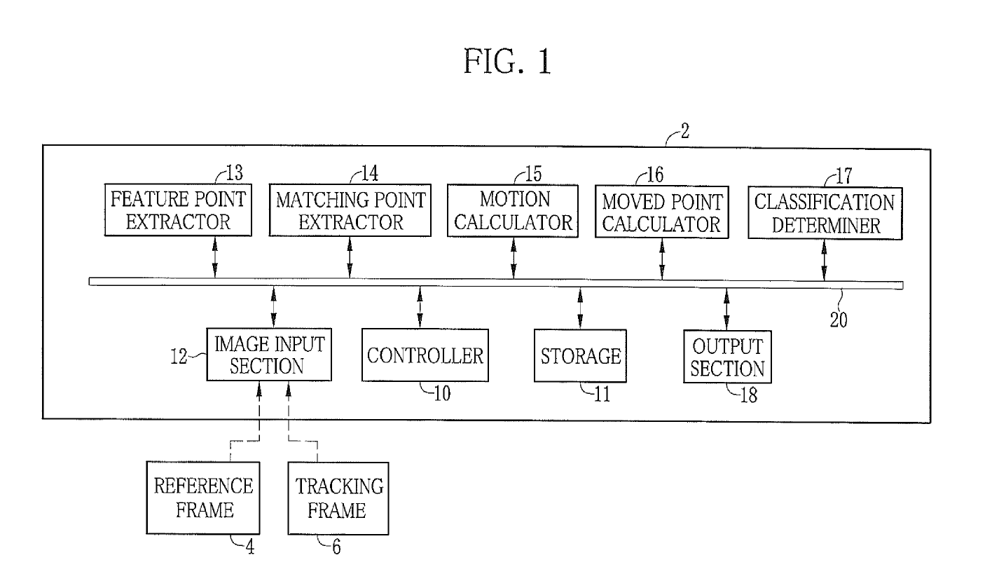

As shown in FIG. 1, an image processing device 2 comprises a controller 10, storage 11, an image input section 12, a feature point extractor 13, a matching point extractor 14, a motion calculator 15, a moved point calculator 16, a classification determiner 17, and an output section 18. These sections are connected to each other through a bus 20.

The storage 11 stores various programs and data necessary to control the image processing device 2 and temporarily stores data generated during the control. The controller 10 reads various programs from the storage 11 and runs the programs sequentially to perform centralized control of each section of the image processing device 2.

The image input section 12 is an interface to externally input a frame (reference frame) 4, being a reference, and a frame (tracking frame) 6 through a network or a recording medium. The reference frame 4 and the tracking frame 6 are consecutive in time series. These consecutive frames are stored in the storage 11 through the image input section 12.

The reference frame 4 and the tracking frame 6 are, for example, two still images successively captured or two successive field images in a moving image. The image processing device 2 performs image processing to detect motion of a subject captured in both of the frames 4 and 6 consecutive in time series. Note that the two frames may not have successive frame numbers as long as a main subject is captured in each of the two frames. Particularly, when a plurality of the tracking frames are used, the tracking frames may be taken out at intervals of N frames.

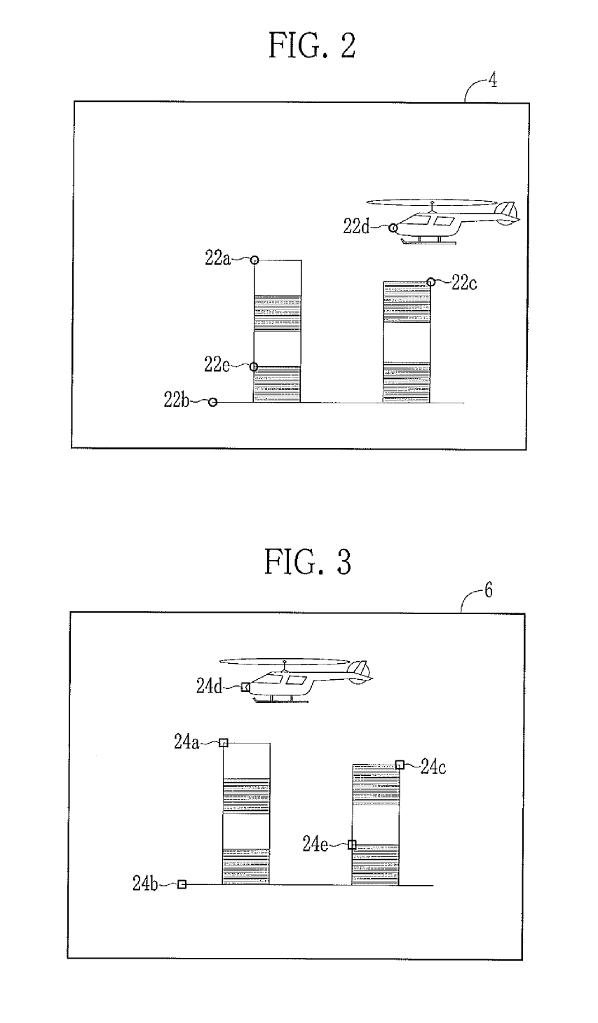

As shown in FIG. 2, the feature point extractor 13 extracts feature points from the reference frame 4. The feature point refers to a small area, on an image within the reference frame 4, which is easily distinguished from other small areas, for example, a corner with an intensity gradient. Upon extracting each feature point 22, the feature point extractor 13 stores coordinate information or the like, being a result of the extraction, in the storage 11. The coordinate information or the like indicates a position of the feature point 22.

FIG. 2 illustrates an example in which five feature points 22a to 22e are extracted. In this specification, note that, for example, “feature point 22” with a numeral with no alphabetical letter is used to indicate each of the feature points (for example, 22a to 22e) for the sake of easy description. An alphabetical letter is added to denote an individual feature point. For example, an individual feature point is denoted as “feature point 22a”. In FIG. 2, the five feature points are extracted by way of example. Actually, more than five feature points are extracted.

As shown in FIG. 3, the matching point extractor 14 extracts matching points 24 corresponding to the respective feature points 22 from the tracking frame 6 with the use of a known technique such as a pattern matching process. Upon extracting each matching points 24, the matching point extractor 14 stores coordinate information or the like, being a result of the extraction, in the storage 11. The coordinate information or the like indicates the position of the matching point 24. At this time, the matching point extractor 14 gives a common identification number or the like to each of the information of the feature point 22 and the information of the corresponding matching point 24 to identify to which feature point 22 the matching point 24 corresponds. Note that, when the feature points are extracted by using the pattern matching process, pixel data (luminance value or the like) used for the pattern matching process for the feature point 22 is obtained from the reference frame 4. As for the matching point 24, the pixel data is obtained from the tracking frame 6.

FIG. 3 illustrates an example in which five matching points 24a to 24e corresponding to the respective feature points 22a to 22e in FIG. 2 are extracted. Similar to the feature points, an alphabetical letter is omitted from the matching point to indicate each of the matching points. An alphabetical letter is added to indicate an individual matching point. The alphabetical letter also shows the correspondence between the matching point 24 and the feature point 22. For example, the matching point 24a corresponds to the feature point 22a.

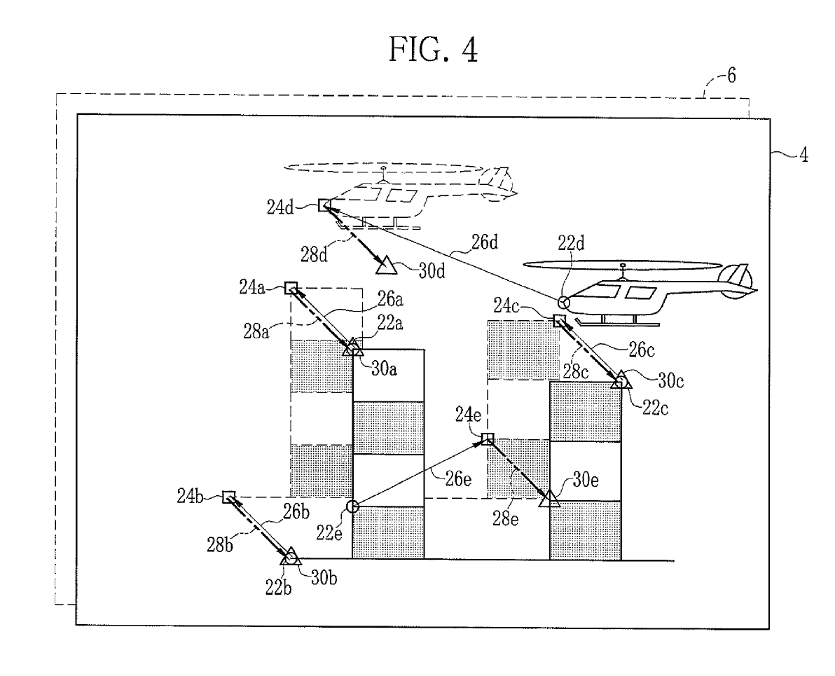

As shown in FIG. 4, the motion calculator 15 obtains a motion vector 26 (a solid arrow in the drawing, also referred to as the optical flow), pointing from the feature point 22 to the matching point 24, for each of the feature points 22 and the matching points 24. The motion calculator 15 performs a conventional method on each motion vector 26 to calculate motion (also referred to as the global motion) of a whole screen caused by a movement of a view point of the tracking frame 6 relative to the reference frame 4. In FIG. 4, note that the reference frame 4 and the tracking frame 6 are slightly shifted from each other for the sake of convenience. Actually, the motion vector 26 is obtained in a state that the frames 4 and 6 overlap completely with each other.

The moved point calculator 16 obtains an inverse vector 28 (an arrow depicted in a chain double-dashed line in the drawing) of motion of a whole screen (whole scene). The inverse vector 28 has the matching point 24 as a starting point. The moved point calculator 16 calculates a position of an endpoint of the inverse vector 28 as a moved point 30. Upon calculating each moved point 30, the moved point calculator 16 stores coordinate information or the like as a calculation result in the storage 11. The coordinate information or the like indicates the position of the moved point 30.

In FIGS. 2 to 4, note that a circular mark denotes the feature point 22. A rectangular mark denotes the matching point 24. A triangular mark denotes the moved point 30. These marks are used to make the positions of the points 22, 24, and 30 recognized easily for the sake of convenience in description. These marks are not actually provided on each of the frames 4 and 6 and do not indicate shapes of the points 22, 24, and 30.

The classification determiner 17 classifies whether the matching point 24 is a stationary point on a stationary image such as a background, a moving point on an image of a moving subject such as a person or a vehicle, or an outlier caused by the scene with a repeated pattern, based on the result of calculating the moved point 30 by the moved point calculator 16.

To classify the matching point 24, first, the classification determiner 17 determines whether the position of the moved point 30, calculated by the moved point calculator 16, is within a predetermined range relative to the position of the corresponding feature point 22. The motion of the whole screen calculated by the motion calculator 15 represents the motion of stationary points. As for the matching point 24, shown by the matching points 24a, 24b, and 24c in FIG. 4, which is provided on the stationary image and in correct correspondence with the feature point 22, the position of the moved point 30 is substantially coincident with the position of the original feature point 22. Hence, upon determining that the position of the moved point 30 is within the predetermined range relative to the position of the corresponding feature point 22, the classification determiner 17 classifies the matching point 24 as the stationary point.

On the other hand, upon determining that the position of the moved point 30 is out of the predetermined range relative to the position of the corresponding feature point 22, the classification determiner 17 then performs the well-known pattern matching process, based on a luminance value or the like, to determine whether the correlation between the moved point 30 and the corresponding feature point 22 is high or not. Note that the pixel data of the moved point 30 is obtained from the reference frame 4 when the correlation is determined using the pattern matching process.

As shown by the matching point 24d in FIG. 4, when the matching point 24 is on an image of a moving object and is incorrect correspondence with the feature point 22, the possibility of an image, of an object highly correlated with the feature point 22, existing at the position of an endpoint of the inverse vector 28 having the matching point 24 as a starting point is extremely low. On the other hand, as shown by the matching point 24e in FIG. 4, when the matching point 24 is on an image of a stationary object and is an outlier, an image, which is highly correlated with the feature point 22, causing the outlier always exists at the position of the endpoint of the inverse vector 28 having the matching point 24 as the starting point.

Hence, upon determining that the correlation between the moved point 30 and the feature point 22 is high, the classification determiner 17 classifies the matching point 24 as the outlier. Upon determining that the correlation is low, the classification determiner 17 classifies the matching point 24 as the moving point. Upon classifying the matching point 24, the classification determiner 17 stores a result of the classification in the storage 11.

The output section 18 is an interface to output a result of image processing performed by the image processing device 2 to outside through a network or a recording medium. The output section 18 reads, for example, the coordinate information of the each feature point 22 extracted by the feature point extractor 13, the coordinate information of the each matching point 24 extracted by the matching point extractor 14, the result of classification of the each matching point 24 classified by the classification determiner 17, or the like and outputs it as a processing result to the outside.

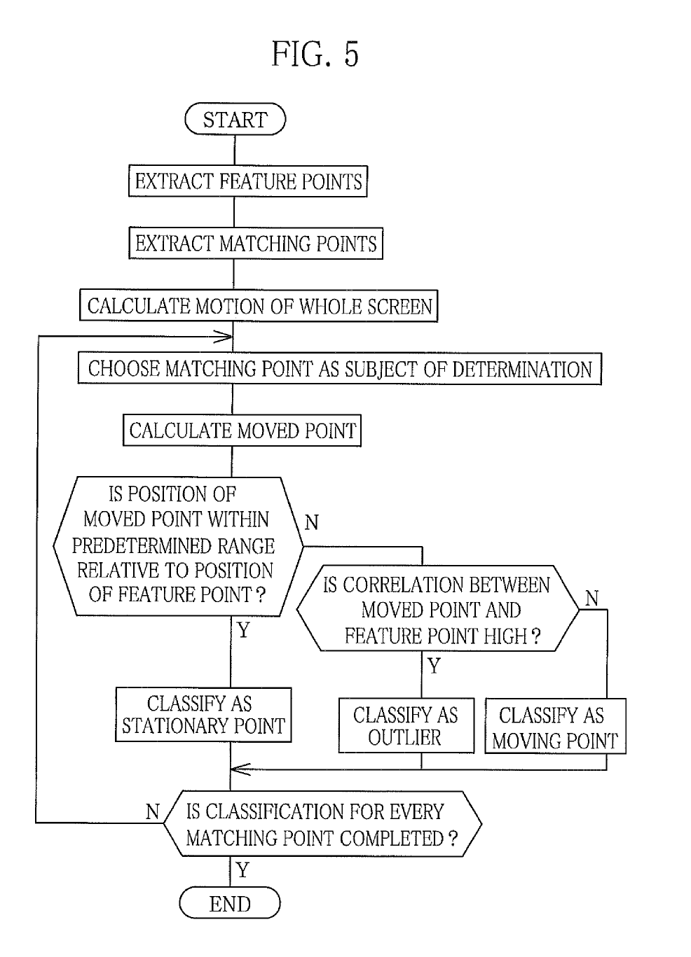

Next, referring to a flowchart in FIG. 5, an operation of the image processing device 2 of the above configuration is described. To allow the image processing device 2 to execute the image processing, first, the reference frame 4 and the tracking frame 6, being subjects of the image processing, are inputted to the image input section 12. When each of the frames 4 and 6 is inputted to the image input section 12, the image input section 12 stores them in the storage 11.

The controller 10 commands the feature point extractor 13 to extract the feature points 22. When the controller 10 commands the feature point extractor 13 to extract the feature points 22, the feature point extractor 13 reads the reference frame 4 from the storage 11 and extracts the feature points 22 from the reference frame 4. The feature point extractor 13 stores the result of the extraction in the storage 11.

Next, the controller 10 commands the matching point extractor 14 to extract the matching points 24. When the controller 10 commands the matching point extractor 14 to extract the matching points 24, the matching point extractor 14 reads the tracking frame 6 and the result of the extraction of the feature points 22 from the storage 11. The matching point extractor 14 extracts the matching points 24, corresponding to the respective feature points 22, from the tracking frame 6. The matching point extractor 14 stores the result of the extraction in the storage 11.

After allowing the matching point extractor 14 to extract the matching points 24, the controller 10 allows the motion calculator 15 to calculate the motion of the whole screen (scene). The controller 10 chooses the matching point 24, being the subject of the determination. The controller 10 allows the moved point calculator 16 to calculate the moved point 30 corresponding to the chosen matching point 24. Thereafter, the controller 10 commands the classification determiner 17 to classify the matching point 24, being the subject of the determination.

When the classification determiner 17 is commanded to classify the matching point 24, the classification determiner 17 reads the coordinate information of the feature point 22 and the coordinate information of the moved point 30. The feature point 22 and the moved point 30 correspond to the matching point 24. The classification determiner 17 determines whether the position of the moved point 30 is within the predetermined range relative to the position of the feature point 22.

Upon determining that the position of the moved point 30 is within a predetermined range relative to the position of the corresponding feature point 22, the classification determiner 17 classifies the matching point 24 as the stationary point. On the other hand, upon determining that the position of the moved point 30 is out of the predetermined range relative to the position of the corresponding feature point 22, the classification determiner 17 determines whether the correlation between the moved point 30 and the feature point 22 is high or not. Upon determining that the correlation is high, the classification determiner 17 classifies the matching point 24 as the outlier. Upon determining that the correlation is low, the classification determiner 17 classifies the matching point 24 as the moving point.

After allowing the classification determiner 17 to classify the matching point 24, the controller 10 chooses the next matching point 24 and repeats the processing in a similar manner. Thereby, the controller 10 allows completion of the classification of every matching point 24 extracted by the feature point extractor 13.

When the classification of the each matching point 24 is completed, the controller 10 outputs a result of the process from the output section 18 to the outside. The result of the process includes the coordinate information of the each feature point 22, the coordinate information of the each matching point 24, the result of the classification of the each matching point 24, and the like.

According to this embodiment, whether the matching point 24 is a stationary point is determined correctly based on whether the position of the moved point 30 is within the predetermined range relative to the position of the feature point 22. Whether the matching point 24 is the moving point or the outlier is determined correctly based on the determination whether the correlation between the moved point 30 and the feature point 22 is high or not. Namely, whether the motion of the matching point 24, detected as not being the stationary point, is due to the motion of the subject or due to the outlier is determined correctly.

As described above, in this embodiment, when the matching point 24 on an image of a moving object is in correct correspondence with the feature point 22, there is a characteristic that the possibility of the image, of the object highly correlated with the feature point 22, existing at the position of the endpoint of the inverse vector 28 having the matching point 24 as the starting point is extremely low. Whether the matching point 24 is the moving point or the outlier is determined with the use of this characteristic. The characteristic does not change even in the scene with a repeated pattern. According to this embodiment, whether the matching point 24 is a stationary point, a moving point, or the outlier is determined correctly even in the scene with a repeated pattern. This means the occurrence of the outlier is prevented properly.

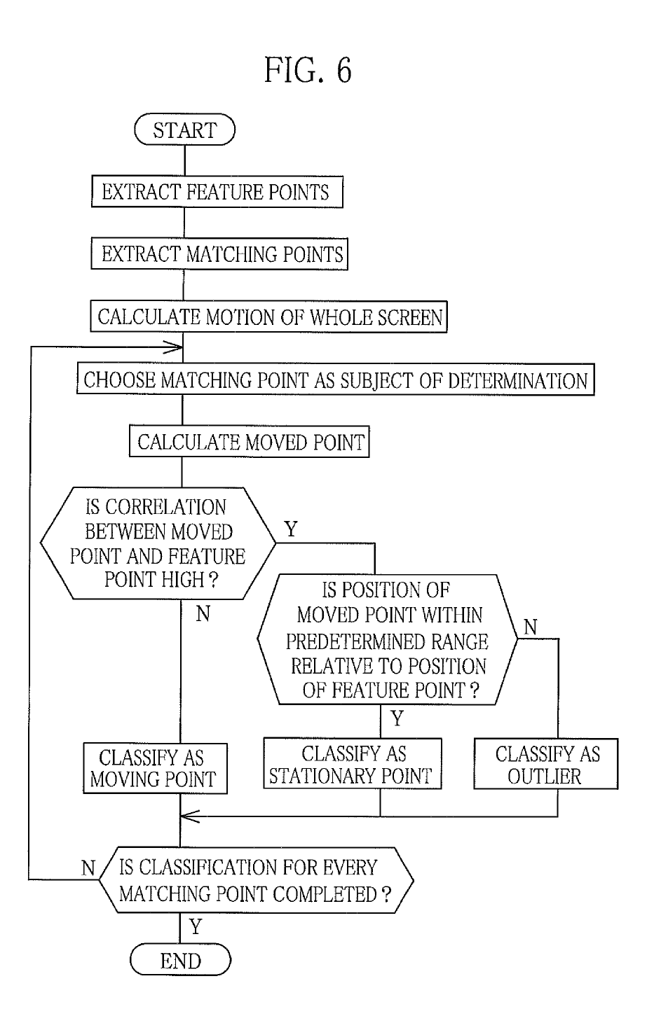

In the above embodiment, to classify the matching point 24, the classification determiner 17 determines whether the position of the moved point 30 is within the predetermined range relative to the position of the feature point 22. Then, upon determining that the position of the moved point 30 is out of the predetermined range, the classification determiner 17 determines whether the correlation between the moved point 30 and the feature point 22 is high or not. The order of the determination may be reversed as shown by a flowchart in FIG. 6.

In a flowchart shown in FIG. 6, whether the correlation between the moved point 30 and the feature point 22 is high or not is determined in response to a command from the controller 10. The command instructs to classify the matching point 24, being the subject of the determination. When it is determined that the correlation is low, the matching point 24 is classified as the moving point. When it is determined that the correlation is high, then, whether the position of the moved point 30 is within the predetermined range relative to the position of the feature point 22 is determined. The matching point 24 is classified as the stationary point when the position of the moved point 30 is determined to be within the predetermined range. The matching point 24 is classified as the outlier when the position of the moved point 30 is determined to be out of the predetermined range.

As described above, whether the matching point 24 is a stationary point, a moving point, or the outlier is determined correctly in a manner similar to the above embodiment even if whether the correlation between the moved point 30 and the feature point 22 is high or not is determined in an earlier step.

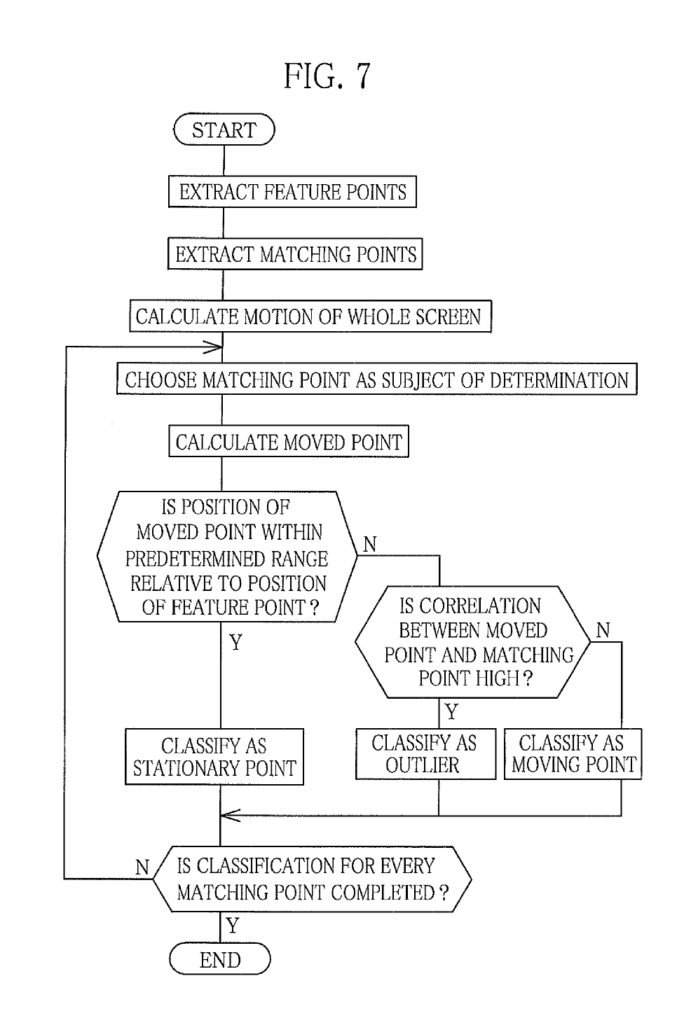

In the above embodiment, whether the correlation between the moved point 30 and the feature point 22 is high or not is determined. As shown by a flowchart in FIG. 7, whether the correlation between the moved point 30 and the matching point 24 is high or not may be determined.

When the matching point 24 is on an image of a moving subject and in correct correspondence with the feature point 22, the possibility of the image, highly correlated with the matching point 24, existing at the position of the moved point 30 is extremely low. Hence, the correlation between the matching point 24 and the moved point 30 is low, similar to the case of the feature point 22. When the matching point 24 is on an image of a stationary subject with the outlier caused by a repeated pattern, the correlation between the feature point 22 and the matching point 24 should be high. Hence, the correlation between the matching point 24 and the moved point 30 becomes high, similar to the case of the feature point 22.

Here, whether the correlation between the moved point 30 and the matching point 24 is high or not is determined. The matching point 24 is classified as the outlier when the correlation is high and classified as the moving point when the correlation is low, similar to the case of the feature point 22. Thus the result similar to the above embodiment is obtained even if whether the correlation between the moved point 30 and the matching point 24 is high or not is determined.

### Second Embodiment

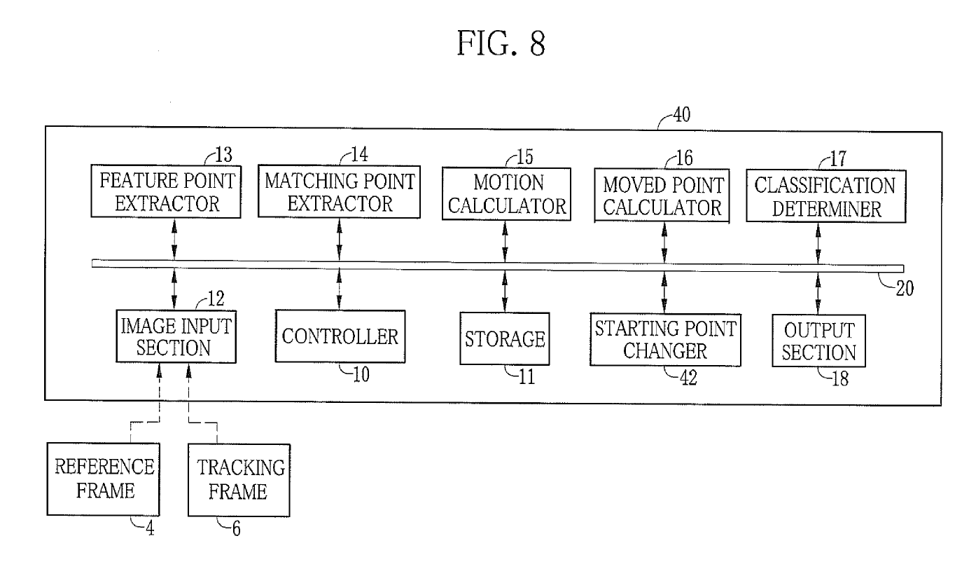

Next, a second embodiment of the present invention is described. Note that, parts functionally and structurally similar to those of the above-described first embodiment have like numerals and detailed descriptions thereof are omitted. As shown in FIG. 8, the image processing device 40 of this embodiment comprises a starting point changer 42 in addition to each section of the image processing device 2 of the first embodiment.

When the classification determiner 17 classifies the matching point 24 as the outlier, the starting point changer 42 changes a starting point of the motion vector 26 of the matching point 24 from the feature point 22 to the moved point 30. Thereby, the starting point changer 42 performs a process to correct the direction and the magnitude of the motion vector 26 of the outlier.

The matching point 24 classified as the outlier is on the still image. Hence, an image corresponding to the matching point 24 exists at a position, on the reference frame 4, of the moved point 30, being the endpoint of the inverse vector 28 of the motion of the whole screen. The position of the moved point 30 is used as the new feature point 22 as described above. Thereby the motion vector 26 in the wrong direction due to the outlier is corrected to the motion vector 26 in the correct direction with the correct magnitude corresponding to the matching point 24.

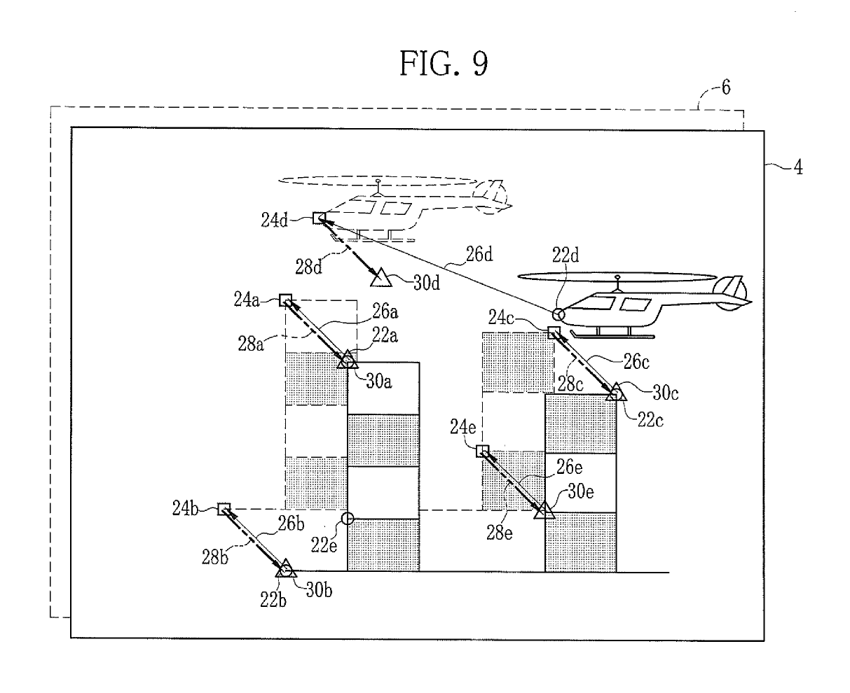

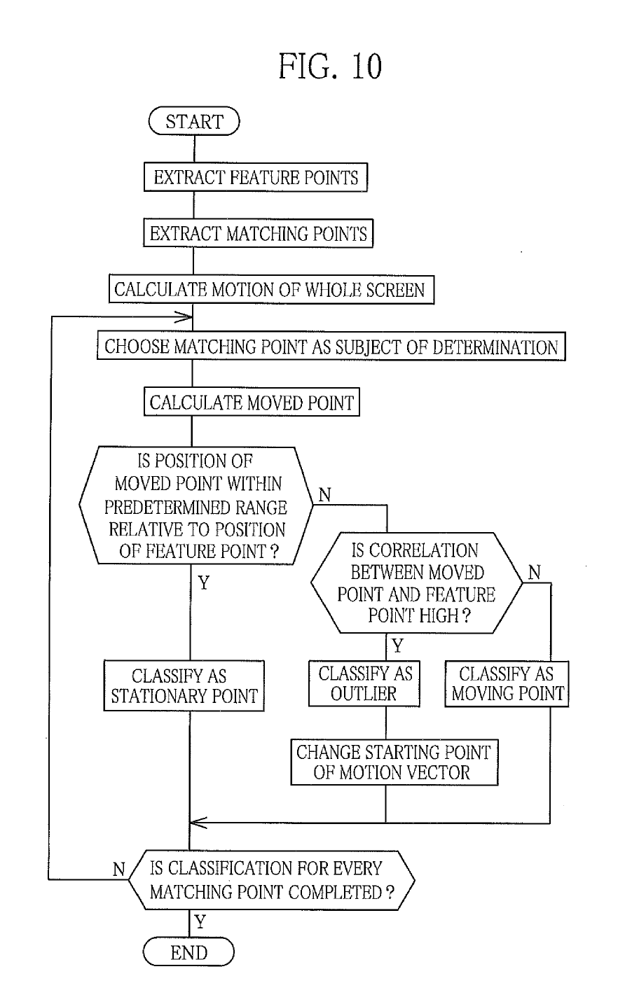

For example, a motion vector 26e in FIG. 4 is in a direction that differs from those of other normal motion vectors 26a to 26c of the stationary points. This is due to the matching point 24e, being the outlier. A starting point of the motion vector 26e is changed from the feature point 22e to a moved point 30e as shown in FIG. 9. The changed motion vector 26e is in the same direction and has the same magnitude as those of the other normal motion vectors 26a to 26c of the stationary points.

Next, referring to a flowchart in FIG. 10, an operation of an image processing device 40 of the above configuration is described. Note that, a process before commanding the classification determiner 17 to classify the matching point 24, being the subject of the determination, is similar to that of the first embodiment so that the description is omitted.

When the classification of the matching point 24 is commanded, the classification determiner 17 reads the coordinate information of the feature point 22 and the coordinate information of the moved point 30 from the storage 11. The feature point 22 and the moved point 30 correspond to the matching point 24. The classification determiner 17 determines whether the position of the moved point 30 is within a predetermined range relative to the position of the feature point 22.

Upon determining that the position of the moved point 30 is within the predetermined range relative to the position of the feature point 22, the classification determiner 17 classifies the matching point 24 as the stationary point. On the other hand, upon determining that the position of the moved point 30 is out of the predetermined range relative to the position of the feature point 22, the classification determiner 17 then determines whether the correlation between the moved point 30 and the feature point 22 is high or not. Upon determining that the correlation is high, the classification determiner 17 classifies the matching point 24 as the outlier. Upon determining that the correlation is low, the classification determiner 17 classifies the matching point 24 as the moving point.

When the classification determiner 17 classifies the matching point 24 as the outlier, the controller 10 commands the starting point changer 42 to change the starting point of the motion vector 26 of the matching point 24. When the controller 10 commands the starting point changer 42 to change the starting point, the starting point changer 42 reads the coordinate information of the respective matching point 24, the feature point 22 corresponding to the matching point 24, and the moved point 30 corresponding to the matching point 24 from the storage 11.

The starting point changer 42 changes the starting point of the motion vector 26 from the feature point 22 to the moved point 30. Thereby, the motion vector 26 of the outlier is corrected to have a correct direction and correct magnitude. By correcting the motion vector 26, the number of the correct vectors 26 is increased.

Note that, by correcting the motion vector 26 as described above, the matching point 24 classified as the outlier becomes the matching point 24 which has the moved point 30 as the starting point and is in correct correspondence with the moved point 30. When the motion vector 26 is corrected, the matching point 24 may be reclassified from the outlier to the stationary point. Instead, the information of correcting the motion vector 26 may be stored while the classification of the matching point 24 remains as the outlier.

### Third Embodiment

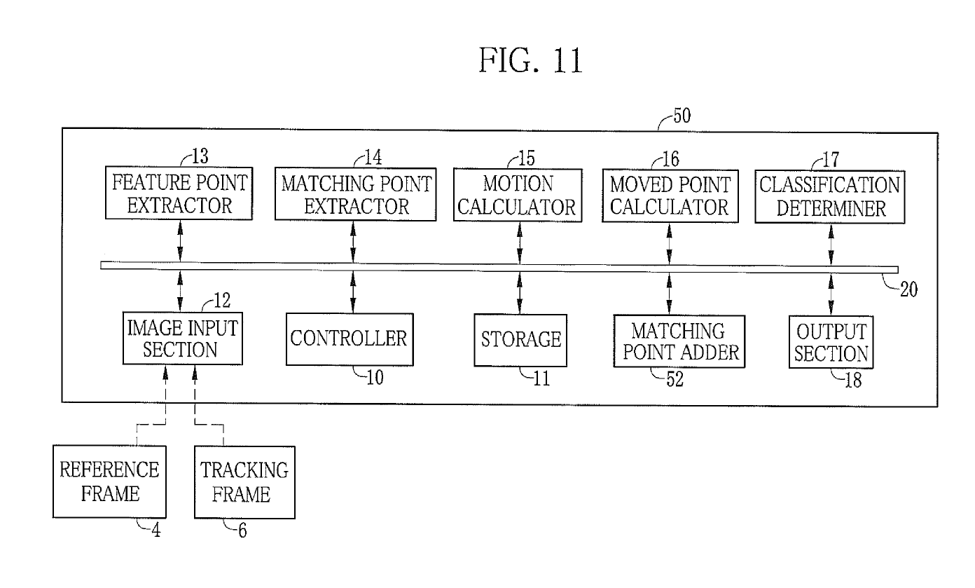

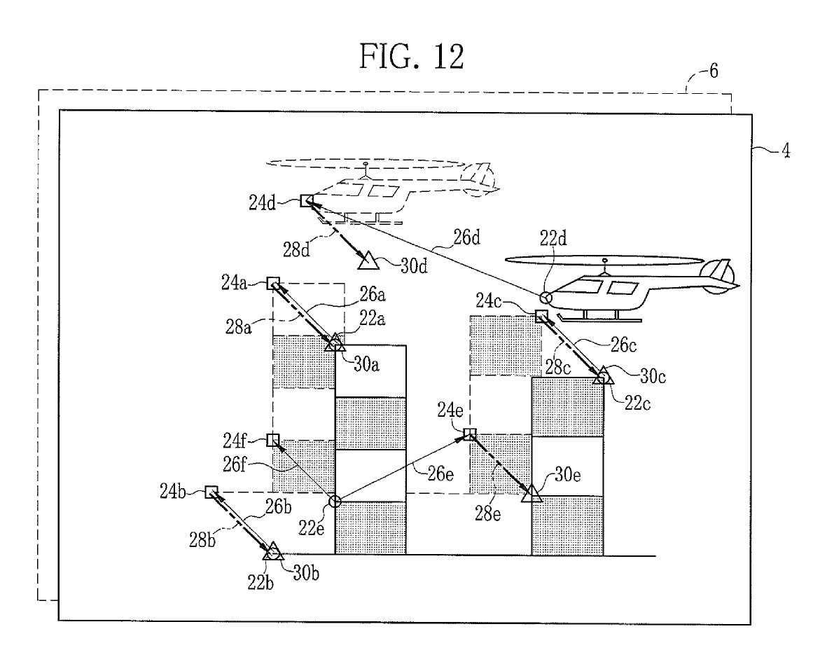

Next, a third embodiment of the present invention is described. As shown in FIG. 11, an image processing device 50 of this embodiment comprises a matching point adder 52 in addition to each section of the image processing device 2 of the above first embodiment. When the classification determiner 17 determines the outlier, the matching point adder 52 performs a process to add a matching point 24 based on the motion vector 26 extending from the feature point 22, corresponding to the matching point 24, and along the motion of the whole screen.

The matching point 24, classified as the outlier, is on an image of a stationary subject. On the tracking frame 6, the feature point 22 corresponding to the matching point 24 is supposed to have moved in a direction and with a moving amount (magnitude) corresponding to the motion of the whole screen. Hence, as described above, by adding the matching point 24 based on the motion vector 26 which extends along the motion of the whole screen, the original motion of the feature point 22, corresponding to the matching point 24 classified as the outlier, is reproduced.

For example, the matching point 24e in FIG. 4 is the outlier. As shown in FIG. 12, a matching point 24f based on a motion vector 26f is added. The motion vector 26f extends from the feature point 22e corresponding to the matching point 24e and extends along the motion of the whole screen. The subject corresponding to the feature point 22e exists at a position of the new matching point 24f on the tracking frame 6. Thus it is confirmed that the original motion of the feature point 22e is reproduced by the matching point 24f.

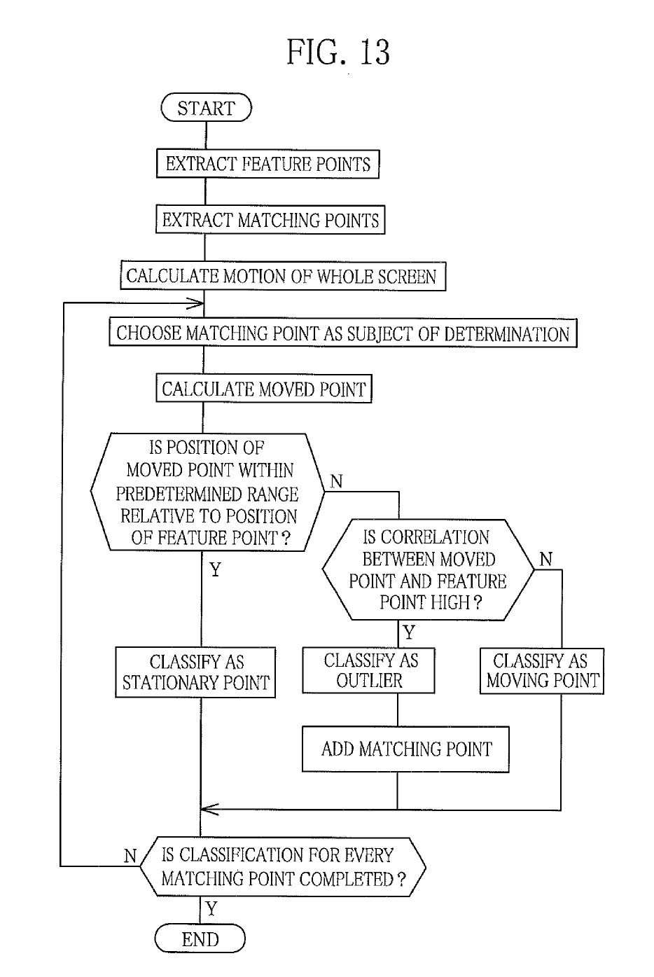

Next, referring to a flowchart in FIG. 13, an operation of the image processing device 50 of the above configuration is described. Note that, a process before commanding the classification determiner 17 to classify the matching point 24, being the subject of determination, is similar to that of the above first embodiment, so that the description thereof is omitted.

When the classification determiner 17 is commanded to classify the matching point 24, the classification determiner 17 reads the coordinate information of the feature point 22 and the coordinate information of the moved point 30 from the storage 11. The feature point 22 and the moved point 30 correspond to the matching point 24. The classification determiner 17 determines whether the position of the moved point 30 is within a predetermined range relative to the position of the feature point 22.

Upon determining that the position of the moved point 30 is within the predetermined range relative to the position of the feature point 22, the classification determiner 17 determines the matching point 24 as the stationary point. Upon determining that the position of the moved point 30 is out of the predetermined range relative to the corresponding feature point 22, the classification determiner 17 then determines whether the correlation between the moved point 30 and the feature point 22 is high or not. Upon determining that the correlation is high, the classification determiner 17 classifies the matching point 24 as the outlier. Upon determining that the correlation is low, the classification determiner 17 classifies the matching point 24 as the moving point.

When the classification determiner 17 has classified the matching point 24 as the outlier, the controller 10 commands the matching point adder 52 to add a matching point 24 to the feature point 22 corresponding to the matching point 24, being the outlier. When the controller 10 commands the matching point adder 52 to add the matching point 24, the matching point adder 52 reads the coordinate information of the feature point 22 from the storage 11 and obtains a result of calculation of the motion of the whole screen calculated by the motion calculator 15.

The matching point adder 52 adds the matching point 24 based on the motion vector extending from the feature point 22 and along the motion of the whole screen. Thereby the original motion of the feature point 22 is reproduced. The number of the correct matching points 24 and the number of the correct motion vectors 26 are increased by adding the matching point 24.

Note that, after the matching point adder 52 added the new matching point 24, a correlation degree between the matching point 24 on the tracking frame 6 and the feature point 22 on the reference frame 4 may be calculated to evaluate validity of the added matching point 24. Thereby whether the added matching point 24 actually reproduced the original motion of the feature point 22 is checked.

A position of an endpoint of the motion vector 26 extending from the feature point 22 and along the motion of the whole screen is calculated. A point having the highest correlation with the feature point 22 is extracted from around the position of the endpoint on the tracking frame 6. The extracted point may be added as the new matching point 24. Thereby the original motion of the feature point 22, corresponding to the matching point 24 classified as the outlier, is more accurately reproduced.

The configuration of this embodiment may be combined with the configuration of the above second embodiment to increase two correct motion vectors 26 on the feature point 22 side and the matching point 24 side.

### Fourth Embodiment

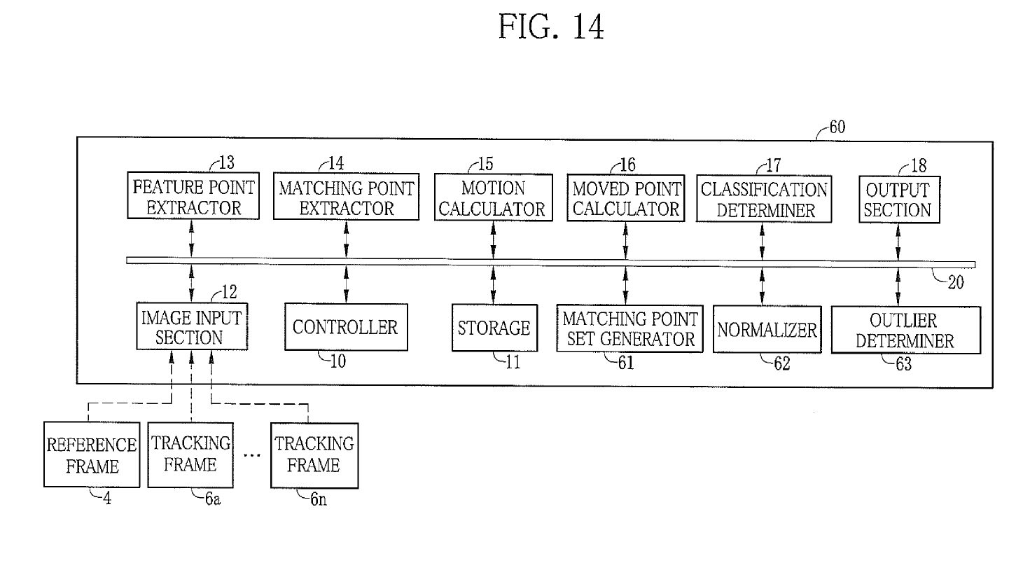

Next, a fourth embodiment of the present invention is described. As shown in FIG. 14, an image processing device 60 of this embodiment comprises a matching point set generator 61, a normalizer 62, and an outlier determiner 63, in addition to each section of the image processing device 2 of the above first embodiment. Tracking frames 6a to 6n are inputted to the image processing device 60. The reference frame 4 and the tracking frames 6a to 6n are consecutive in time series.

The image processing device 60 extracts the matching points 24 from each of the tracking frames 6a to 6n in steps similar to the above first embodiment. The image processing device 60 determines the outlier of the moving point based on the matching points 24 extracted from each of the tracking frames 6a to 6n.

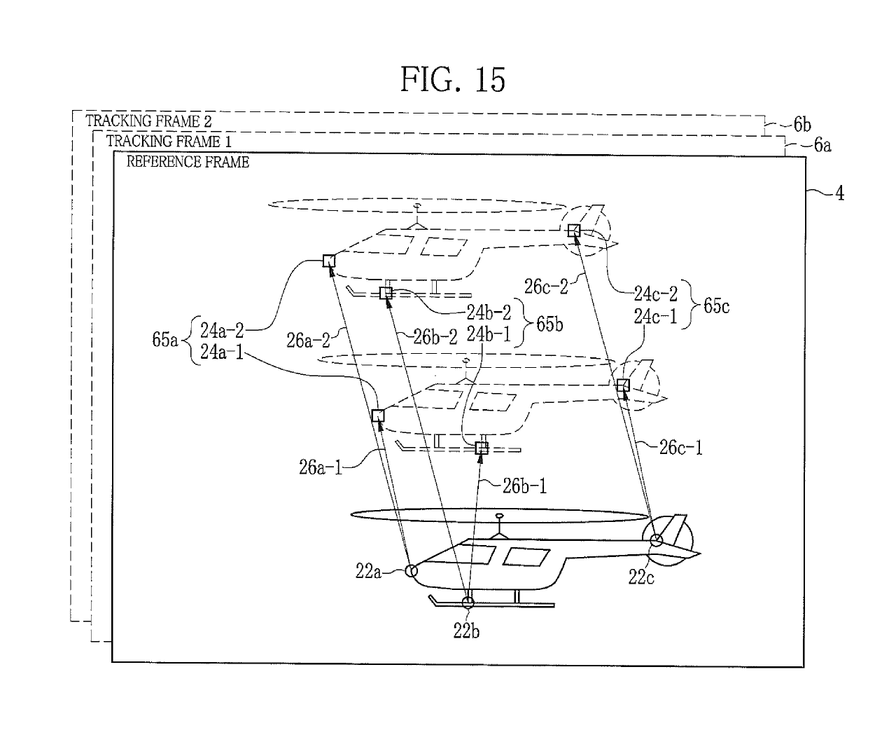

As shown in FIG. 15, when the matching points 24 are extracted from each of the frames 6a to 6n and each of the matching points 24 is classified as the moving point, the matching point set generator 61 groups the matching points 24 corresponding to the same feature point 22 as a matching point set 65 based on the identification information provided to the each matching point 24 in advance.

For example, in FIG. 15, three feature points 22a, 22b, and 22c are extracted from the reference frame 4. Three matching points 24a-1, 24b-1, and 24c-1 corresponding to the respective feature points 22 are extracted as the moving points from the first tracking frame 6a. The reference frame 4 and the first tracking frame 6a are consecutive in time series. Three matching points 24a-2, 24b-2, and 24c-2 corresponding to the respective feature points 22 are extracted as the moving points from the second tracking frame 6b by way of example. The first and second tracking frames 6a and 6b are consecutive in time series. Note that the tracking frames 6a to 6n may be taken out at intervals of N frames.

The matching point set generator 61 groups the matching points 24a-1 and 24a-2, corresponding to the feature point 22a, as a matching point set 65a. The matching point set generator 61 groups the matching points 24b-1 and 24b-2, corresponding to the feature point 22b, as a matching point set 65b. The matching point set generator 61 groups the matching points 24c-1 and 24c-2, corresponding to the feature point 22c, as a matching point set 65c.

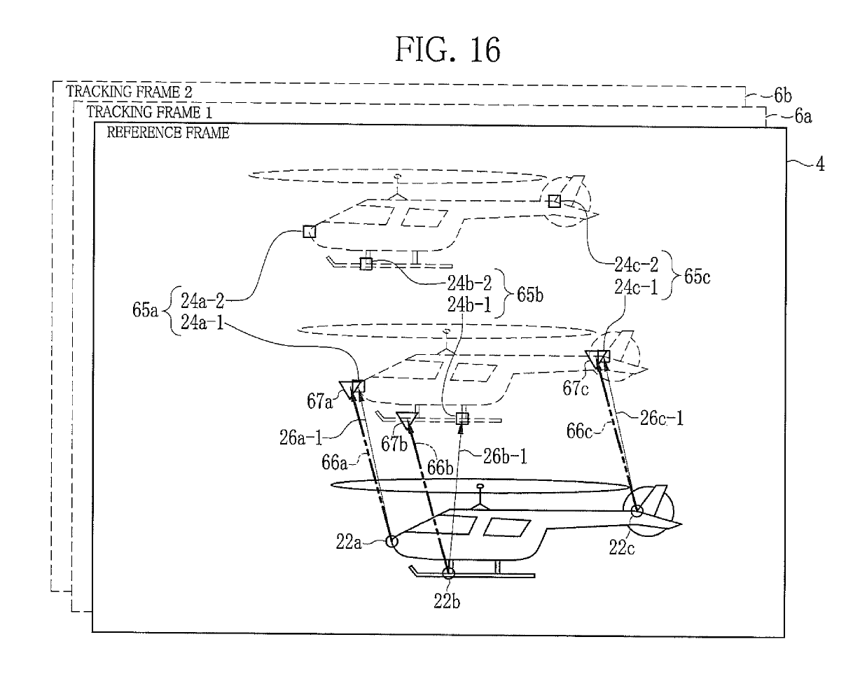

The normalizer 62 uses an imaging time interval of the tracking frames 6a to 6n as a unit time. The motion vector 26 of the each matching point 24 included in the matching point set 65 is normalized to magnitude per unit time. Thereby, as shown in FIG. 16, the normalizer 62 generates a normalized motion vector 66 (hereinafter referred to as the normalized vector 66). A matching point (hereinafter referred to as the normalized matching point) 67 which has been normalized is obtained as shown by a middle-sized inverted triangular mark in the drawing. Note that imaging time intervals of the tracking frames 6a to 6n are provided in advance in header information of each of the tracking frames 6a to 6n, for example.

In an example of FIG. 15, when the tracking frames 6a and 6b are captured at the regular imaging time intervals from the reference frame 4, for example, the normalizer 62 normalizes the moving amount of each of the motion vectors 26a-2, 26b-2, and 26c-2 of the second tracking frame 6b to ½ as shown in FIG. 16. Thereby normalized vectors 66a, 66b, and 66c corresponding to the respective motion vectors 26a-2, 26b-2, and 26c-2 are generated. Note that in the third tracking frame 6c, the moving amount of the motion vector is normalized to ⅓.

The outlier determiner 63 determines whether the correspondence between the matching points 24 and 67 included in the matching point set 65 is correct based on the normalized matching points 24 and 67. For example, the outlier determiner 63 uses a barycentric position of each of the matching points 24 and 67, constituting the matching point set 65, as a reference. The outlier determiner 63 determines that the correspondence between the matching points 24 and 67 is correct when distance from the reference position is less than or equal to a predetermined value. The outlier determiner 63 determines the matching points 24 and 67 as the outlier when the distance from the reference position is greater than the predetermined value.

Alternatively, one of the matching points 24 and 67 in the matching point set 65 is chosen as the reference. The correspondence between the matching points 24 and 67 is determined to be correct when a distance from the reference matching point 24 or 67 is less than or equal to a predetermined value. The matching point 24 or 67 is determined as the outlier when the distance from the reference matching point 24 or 67 is greater than the predetermined value. As shown in FIG. 16, when there are only two matching points 24 and 67, a distance between them may be obtained. The correspondence between the matching points 24 and 67 is determined to be correct when the distance between them is less than or equal to the predetermined value. Both of the matching points 24 and 67 may be determined as the outliers when the distance between them is greater than the predetermined value. When there are three or more matching points 24 and 67, all of them may be determined as the outliers when the distances between them are long.

For example, in FIG. 16, the matching point 24a-1 and a normalized matching point 67a are close to each other. The matching point 24c-1 and a normalized matching point 67c are close to each other. Hence, the outlier determiner 63 determines that each of the matching point 24 and 67 is correct. As for the matching point 24b-1 and a normalized matching point 67b, a distance from the normalized matching point 67b to the matching point 24b-1 is long when the normalized matching point 67b is the reference, for example. Hence, the outlier determiner 63 determines the matching point 24b-1 as the outlier.

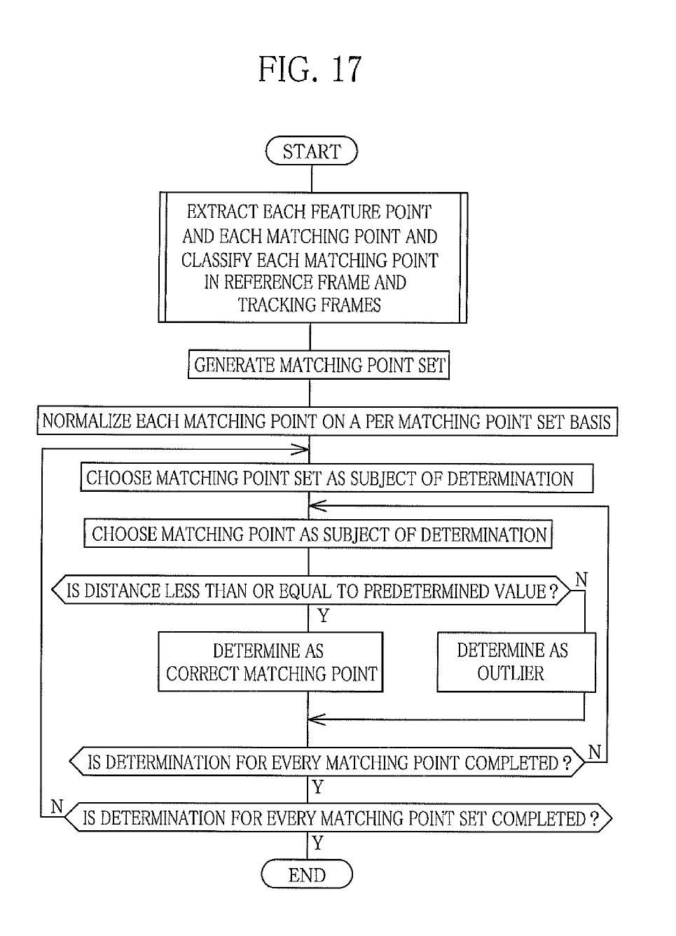

Next, referring to a flowchart in FIG. 17, an operation of the image processing device 60 of the above configuration is described. To allow the image processing device 60 to execute image processing, first, the reference frame 4 and the tracking frames 6a to 6n, being the subjects of the processing, are inputted to the image input section 12. The each feature point 22 is extracted, the each matching point 24 is extracted, and the each matching point 24 is classified in steps similar to the above first embodiment. Note that these processes may follow the steps of the above second or third embodiment.

The controller 10 allows the classification determiner 17 to classify each matching point 24. Then, the controller 10 commands the matching point set generator 61 to generate the matching point set 65. When the controller 10 commands the matching point set generator 61 to generate the matching point set 65, the matching point set generator 61 reads information of each matching point 24, classified as the moving point, based on a result of the classification made by the classification determiner 17, from the storage 11. The matching point set generator 61 groups the matching points 24, corresponding to the same feature point 22, as the matching point set 65.

The controller 10 commands the normalizer 62 to execute the normalization after the matching point set 65 is generated. The motion vector 26 of the each matching point 24 included in the matching point set 65 is normalized to magnitude per unit time. Thereby the normalized matching point 67 is obtained.

After the normalization of the matching point 24, the controller 10 chooses the matching point set 65, being the subject of determination. The controller 10 chooses the matching points 24 and 67, being the subjects of determination, out of the matching points included in the matching point set 65. The controller 10 commands the outlier determiner 63 to determine whether the correspondence between the matching points 24 and 67 is correct.

When the controller 10 commands the outlier determiner 63 to execute the determination, the outlier determiner 63 determines the barycentric position of each of the matching points 24 and 67 constituting the matching point set 65 or one of the matching points 24 and 67 in the matching point set 65 as the reference. The outlier determiner 63 determines whether the distance between the reference and the matching point 24 or 67, being the subject of the determination, is less than or equal to a predetermined value or not. The outlier determiner 63 determines that the correspondence between the matching points 24 and 67 is correct when the distance is less than or equal to the predetermined value. The outlier determiner 63 determines the matching points 24 or 67 as the outlier when the distance is greater than the predetermined value.

After allowing the outlier determiner 63 to perform the determination, the controller 10 allows the outlier determiner 63 to perform the determination for every matching point 24 and 67 included in the matching point set 65, being the subject of the determination. The controller 10 allows the outlier determiner 63 to perform the similar process to every matching point set 65 generated by the matching point set generator 61. Thereby the process is completed. According to this embodiment, the outlier of the matching point 24 classified as the moving point is eliminated properly.

### Fifth Embodiment

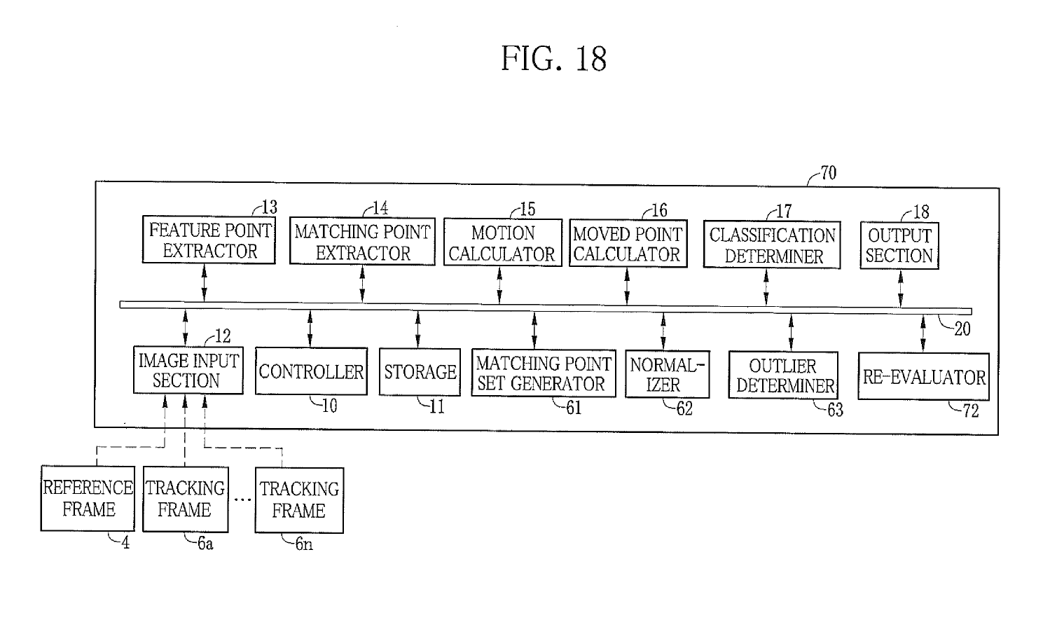

Next, a fifth embodiment of the present invention is described. As shown in FIG. 18, an image processing device 70 of this embodiment comprises a re-evaluator 72, in addition to each section of the image processing device 60 of the above fourth embodiment.

The re-evaluator 72 re-evaluates whether the matching point 24 or the normalized matching point 67 is valid when the number of the correct matching point 24 or the normalized matching point 67 in the matching point set 65 is one due to failure of the matching point extractor 14 to extract the matching point 24 or due to the outlier determined as described in the above fourth embodiment. Upon evaluating that the matching point 24 or the normalized matching point 67 is valid, the re-evaluator 72 determines that the correspondence of the matching point 24 or the normalized matching point 67 is correct. Upon evaluating that the matching point 24 or the normalized matching point 67 is not valid, the re-evaluator 72 determines that the matching point 24 or the normalized matching point 67 as the outlier.

To re-evaluate, for example, the re-evaluator 72 evaluates the correlation between the feature point 22 and the matching point 24 or the normalized matching point 67 based on a strict condition with the use of a threshold value higher than that used in the extraction performed by the matching point extractor 14. At this time, whether the feature point 22 is an appropriate feature point may be included in the evaluation. For example, it is evaluated that whether the feature point 22 is neither a flat portion nor an edge, but is an apex of the subject.

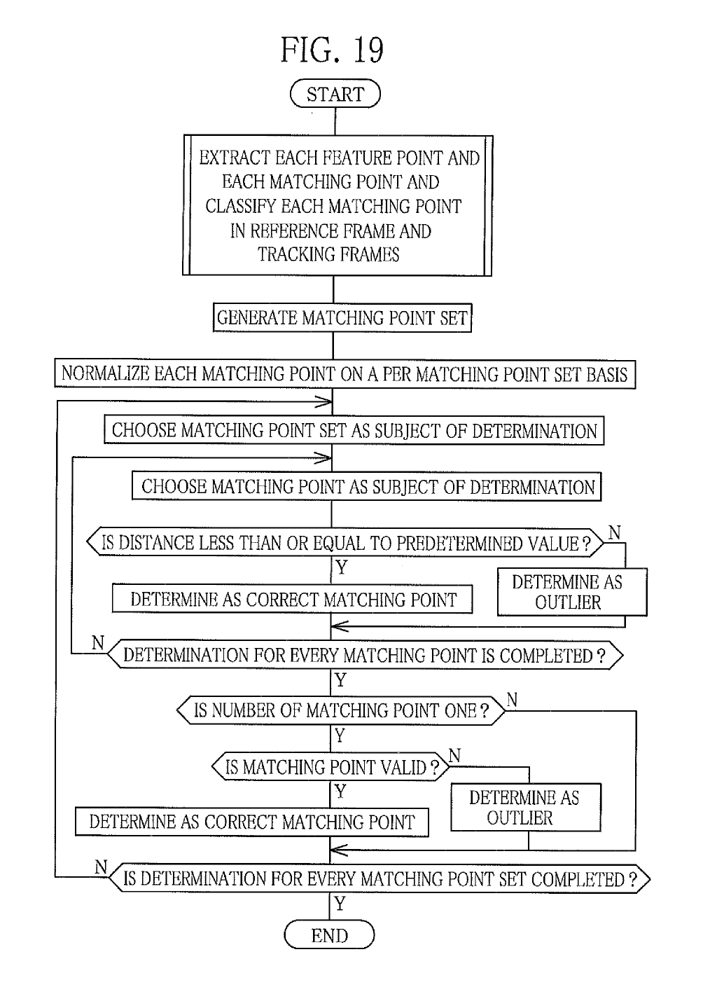

Next, referring to a flowchart in FIG. 19, an operation of the image processing device 70 of the above configuration is described. Note that, a process before the determination of the outlier performed on each of the matching points 24 and 67 included in the matching point set 65, being the subject of the determination, is similar to those of the above fifth embodiment, so that the descriptions thereof are omitted.

The controller 10 detects whether the number of the matching point 24 or 67 included in the matching point set 65 is one after the determination of the outlier performed on each of the matching point 24 and 67 included in the matching point set 65, being the subject of the determination. Upon determining that only one matching point 24 or normalized matching point 67 is included, the controller 10 commands the re-evaluator 72 to execute the re-evaluation.

When the execution of the re-evaluation is commanded, the re-evaluator 72 evaluates the correlation between the matching point 24 or the normalized matching point 67 and the feature point 22 based on the condition stricter than that of the matching point extractor 14. Thereby, the re-evaluator 72 re-evaluates whether the matching point 24 or the normalized matching point 67 is valid. Upon evaluating that the matching point 24 or the normalized matching point 67 is valid, the re-evaluator 72 determines that the correspondence of the matching point 24 or the normalized matching point 67 is correct. Upon evaluating that the matching point 24 or the normalized matching point 67 is not valid, the re-evaluator 72 determines the matching point 24 or the normalized matching point 67 as the outlier.

After allowing the re-evaluator 72 to re-evaluate, the controller 10 allows the re-evaluator 72 to perform the similar process on the each matching point set 65 generated by the matching point set generator 61. Thus the process is completed. According to this embodiment, the outlier of the matching point 24 classified as the moving point is eliminated with high accuracy. The re-evaluator 72 re-evaluates only the matching point 24 or 67 with a high possibility of being the outlier after the classification determiner 17 and the like performed various types of determination. Thereby the outlier is determined and eliminated efficiently.

The storage 11 stores the position coordinate of the each feature point 22, the position coordinate of the each matching point 24, the result of the classification whether the matching point is the stationary point or the moving point, the motion vector 26 of the each feature point calculated by the motion calculator 15, the inverse vector 28 obtained by the moved point calculator 16 based on the motion of the whole screen obtained by the motion calculator 15, and the like. These pieces of motion information are sent to an external device through the output section 18.

The motion information is used for dividing the frame into areas based on the size of the motion vector, obtaining a moving amount of the subject on the frame based on the length of the motion vector, or obtaining a direction of the motion of the subject based on the direction of the motion vector, for example. The image processing is performed based on the obtained information.

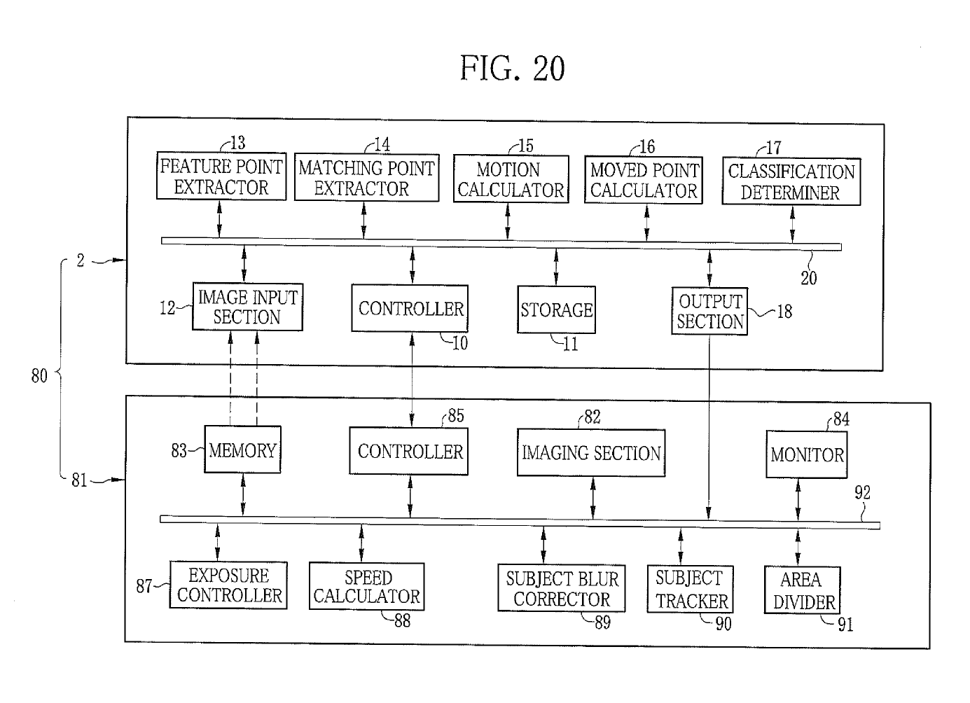

In each of the above embodiments, the image processing device is a discrete device. The image processing device of the present invention may be incorporated in a digital camera, a broadcast TV camera, or the like. FIG. 20 illustrates an embodiment in which the image processing device of FIG. 1 is incorporated in a digital camera. A digital camera 80 comprises the image processing device 2 and a camera section 81. The camera section 81 comprises an imaging section 82, a memory 83, a monitor 84, a controller 85, and the like.

The imaging section 82 has an imaging optical system and an image sensor as is well known. The imaging section 82 captures a still image or a moving image of a scene and stores it in the memory 83. The memory 83 has first storage and second storage. The first storage stores the still image or the moving image captured. The second storage temporarily stores a moving image (hereinafter referred to as through image) during framing before the still image is captured. The monitor 84 displays the through image during the framing of a still image. The monitor 84 displays a captured still image or a captured moving image when the captured image is reproduced. During the framing, the moving image temporarily stored in the second storage is transmitted from the memory 83 to the image processing device 2. When the image is reproduced, the stored moving image or the stored still image is transmitted from the memory 83 to the image input section 12 of the image processing device 2. The controller 85 controls each circuit in the camera section 81. The controller 85 commands the controller 10 of the image processing device 2 to execute detection of motion of the subject.

The camera section 81 is provided with an exposure controller 87, a speed calculator 88, a subject blur corrector 89, a subject tracker 90, and an area divider 91. The exposure controller 87 sets exposure conditions (an aperture value, a shutter speed (charge storage time)) based on a moving speed of a moving subject calculated by the speed calculator 88. The subject blur corrector 89 moves a correction lens in an imaging optical system in accordance with the direction of motion of the moving subject. Thereby, the subject blur corrector 89 corrects a subject blur. The subject tracker 90 tracks the motion of a chosen subject. The subject with the marks is displayed on the monitor. The area divider 91 divides the frame in accordance with the moving amount. Note that a numeral 92 is a bus.

During the framing of the still image, the moving image temporarily stored in the second storage of the memory 83 is transmitted to the image input section 12 of the image processing device 2. As described above, the image processing device 2 compares the images between frames to obtain motion information of the through image. The motion information is transmitted to the camera section 81 through the output section 18.

The speed calculator 88 uses the motion vector 26 and the inverse vector 28 out of the motion information of the through image. The speed calculator 88 subtracts the length of the inverse vector from the length of the motion vector. Thereby, the speed calculator 88 calculates a moving amount of a moving subject (moving object) on the frame. The speed of the moving subject is obtained from the moving amount, the subject distance, a focal length of an imaging lens system, or the like. The exposure controller 87 calculates a shutter speed, not causing the subject blur, based on the speed of the moving subject. An aperture value is calculated from the subject brightness and the shutter speed. When the still image is captured, an exposure is controlled based on the shutter speed and the aperture value obtained by the exposure controller 87. The speed of the moving object may be displayed on the monitor 84.

Based on the direction and the magnitude of the motion vector on the frame, the subject blur corrector 89 obtains a moving direction and a moving amount of the correction lens for correcting the subject blur. The subject blur corrector 89 moves the correction lens during the image capture of the still image and corrects the subject blur. Thereby a sharp still image is recorded.

The subject tracker 90 tracks the motion of the chosen subject and displays the chosen subject with the marks on the monitor 84. The motion of the moving subject of interest in the frame is shown.

The area divider 91 divides the frame into a motion area and a stationary area based on the magnitude of the motion vector. The area divider 91 performs a noise reduction process and a color chroma adjustment on each of the stationary and motion areas. The motion area is a moving subject. The motion area may be cut out and attached to another frame to synthesize an image. The stationary area may be cut out and attached to another frame. Note that the area division and the image processing based on the area division are performed on the recorded still image or the recorded moving image.

The exposure controller 87, the speed calculator 88, the subject blur corrector 89, the subject tracker 90, and the area divider 91 may be provided in the image processing device 2.

Note that, in the above embodiments, the translationally-moved subject is described. The motion of the whole screen may represent the motion of the stationary point in rotation, scaling, or a combined movement of the subject. According to the present invention, the matching point 24 is determined properly as described in the above embodiments even if the subject is moved translationally, rotated, enlarged, reduced, or in a combined movement thereof.

Various changes and modifications are possible in the present invention and may be understood to be within the present invention.

What is claimed is:

1. An image processing device comprising:
a feature point extractor for extracting feature points from a reference frame;
a matching point extractor for extracting matching points from a tracking frame, the reference frame and the tracking frame being consecutive in time series, the matching points corresponding to the feature points;
a motion calculator for calculating motion of a whole screen of the tracking frame relative to the reference frame based on a motion vector from the feature point to the matching point;
a moved point calculator for obtaining an inverse vector, of the motion of the whole screen, having the matching point as a starting point, and calculating a position of an endpoint of the inverse vector as a moved point; and
a classification determiner for determining whether a position of the moved point is within a predetermined range relative to a position of the feature point, and classifying the matching point as a stationary point when the position of the moved point is within the predetermined range, and determining a correlation between the feature point and the moved point or a correlation between the matching point and the moved point when the position of the moved point is out of the predetermined range, and classifying the matching point as an outlier when the correlation is high and classifying the matching point as a moving point when the correlation is low.

2. The image processing device of claim 1, further comprising a starting point changer for changing a starting point, of the motion vector of the matching point, from the feature point to the moved point when the matching point is classified as the outlier.

3. The image processing device of claim 1, further comprising a matching point adder for adding a matching point based on the motion vector extending from the feature point corresponding to the matching point, being the outlier, and along the motion of the whole screen when the matching point is classified as the outlier.

4. The image processing device of claim 1, comprising:
a matching point set generator for grouping the matching points as a matching point set when the matching points are extracted from each of the tracking frames and the each matching point is classified as the moving point, the reference frame and the tracking frames being consecutive in time series;
a normalizer for normalizing the motion vector of the each matching point included in the matching point set to magnitude per unit time; and
an outlier determiner for checking whether a distance from the each matching point after normalization is less than or equal to a predetermined value, and determining that correspondence between the each matching point included in the matching point set is correct when the distance is less than or equal to the predetermined value, and determining that the outlier is included in the matching points included in the matching point set when the distance is greater than the predetermined value.

5. The image processing device of claim 4, further comprising a re-evaluator for re-evaluating whether the matching point is valid when the matching point set includes the only one matching point.

6. The image processing device of claim 1, further comprising a speed calculator for calculating a speed of a subject, corresponding to an image in the frame, based on a length of the motion vector and a length of the inverse vector.

7. The image processing device of claim 6, further comprising an exposure controller for setting an exposure condition for preventing a subject blur based on the speed of the subject.

8. The image processing device of claim 1, further comprising a subject blur corrector for determining a direction of motion of a subject based on a direction of the motion vector and correcting a subject blur.

9. The image processing device of claim 1, further comprising a subject tracker for determining a direction of motion of a subject based on a direction of the motion vector and tracking the subject.

10. The image processing device of claim 1, further comprising an area divider for dividing the frame into a motion area and a stationary area based on magnitude of the motion vector and performing image processing in accordance with a type of the area.

11. An image processing method comprising:
extracting feature points from a reference frame;
extracting matching points from a tracking frame, the reference frame and the tracking frame being consecutive in time series, the matching points corresponding to the feature points;
calculating motion of a whole screen of the tracking frame relative to the reference frame based on a motion vector from the feature point to the matching point;
obtaining an inverse vector, of the motion of the whole screen, having the matching point as a starting point and calculating a position of an endpoint of the inverse vector as a moved point; and
determining whether a position of the moved point is within a predetermined range relative to a position of the feature point, and classifying the matching point as a stationary point when the position of the moved point is within the predetermined range, and determining a correlation between the feature point and the moved point or a correlation between the matching point and the moved point when the position of the moved point is out of the predetermined range, and classifying the matching point as an outlier when the correlation is high and classifying the matching point as a moving point when the correlation is low.
